(19) United States
(12) Patent Application Publication
(10) Pub. No.: US 2017/0192635 A1
(43) Pub. Date: Jul. 6, 2017

(54) MOBILE APPLICATION CONFIGURATION BASED ON GEOGRAPHIC AND TRANSACTION HISTORY CONTEXT

(71) Applicant: BANK OF AMERICA CORPORATION, Charlotte, NC (US)

(72) Inventors: Alicia C. Jones-McFadden, Fort Mill, SC (US); Linda Yoon Lentz, San Jose, CA (US); Gail Mohr, Fort Mill, SC (US); Matthew Hsieh, Charlotte, NC (US)

(21) Appl. No.: 14/987,746

(22) Filed: Jan. 4, 2016

(51) Int. Cl. G06F 3/0484; G06F 9/44; G06Q 30/02; G06F 3/0482

(52) U.S. Cl. CPC G06F 3/0484; G06F 3/0482; G06F 9/4446; G06Q 30/0202

(57) ABSTRACT

Embodiments of the invention are directed to systems, methods, and computer program products for mobile application configuration based on geographic and transaction history context. The system is configured to receive an indication that a user device associated with a user is within a predetermined distance from a facility; predict one or more reasons for the user's visit to the facility; present the predicted reasons to the user via a first user interface on the user device; receive user selection of at least one reason; dynamically transform the first user interface to enable the user to execute a transaction associated with the selected reason for the user's visit to the facility; receive user input to initiate the transaction via the transformed first user interface; and initiate the execution of the transaction.

### FIELD

The present invention relates to modifying the configuration of a mobile application based on predetermined contexts such as a user's visit to the facility.

### BACKGROUND

Recent trends in technology and mobile telecommunication has enabled entities to explore in-store analytics to predict the purpose of a customer visit to better enable the entity to service the customer. By maintaining a record of a customer visit, an entity may be able to predict the reason for the user's visit to the facility and determine how best to assist the customer. As such, there is a need for a system to dynamically modify the configuration of the mobile device to provide efficient customer interaction service.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer program products, and methods are described herein for mobile configuration based on geographic and transaction history context. In one embodiment, a system for mobile application configuration based on geographic and transaction history context is presented. The system comprises at least one non-transitory storage device; at least one processor; and at least one module stored in said storage device and comprising instruction code that is executable by the at least one processor and configured to cause said at least one processor to: receive an indication that a user device associated with a user is within a predetermined distance from a facility, the facility being associated with an entity; predict one or more reasons for the user's visit to the facility based on at least receiving the indication that the user device is within a predetermined distance from the facility, wherein the one or more reasons for the user's visit is predicted based on at least a predetermined pattern associated with the user's previous visits to the facility; establish a communication link with the user device, wherein the establishing further comprises establishing a data channel to access the user device; initiate a presentation of a first user interface for display on the user device, wherein the first user interface comprises one or more reasons for the user's visit to the facility and one or more options for the user to execute one or more transactions associated with the one or more reasons; receive, via the first user interface, a user selection of at least one of the one or more reasons for the user's visit to the facility; dynamically transform the first user interface to enable the user to execute one or more transactions associated with the at least one of the selected reasons for the user's visit to the facility, whereby the transformation enables the user to initiate execution of one or more transactions efficiently; receive, via the transformed first user interface, a user input to initiate the execution of one or more transactions associated with the at least one of the selected reasons for the user's visit to the facility; and initiate the execution of the one or more transactions associated with the at least one of the selected reasons for the user's visit to the facility.

In some embodiments, the module is further configured to cause the at least one processor to: receive information associated with the user's previous visits to the facility; determine one or more transactions executed by the user during the user's previous visits; and identify a pattern associated with the user's previous visits to the facility based on at least one or more transactions executed by the user during the user's previous visits to the facility; and predict the one or more reasons for the user's visit to the facility based on at least the pattern associated with the user's previous visits to the facility.

In some embodiments, the module is further configured to cause the at least one processor to: initiate, via the transformed first user interface, an option to enable the user to initiate a partial execution of one or more transactions; receive, via the transformed first user interface, an indication that the user has initiated the partial execution of one or more transactions, wherein receiving further comprises receiving information associated with the partial execution of one or more transactions; and transmit, via the transformed first user interface, a notification to the user indicating a successful partial execution of the one or more transactions, wherein the notification further comprises information associated with completing the partial execution of the one or more transactions when the user arrives at the facility.

In some embodiments, the module is further configured to cause the at least one processor to: transmit, via the transformed first user interface, information to aid the user in the execution of the one or more transactions, wherein the information comprises at least a video tutorial, a list of instructions, and direct communication line with an agent associated with the facility, wherein the direct communication line comprises a phone call, an instant messenger session, a text message, a pop up message, and an email.

In some embodiments, the module is further configured to cause the at least one processor to: initiate a presentation of an authentication interface for display on the user device in response to receiving the indication that a user device associated with a user is within a predetermined distance from a facility; receive, via the authentication interface, one or more authentication credentials from the user; validate the one or more authentication credentials; and establish the communication link with the user device, wherein the establishing further comprises establishing a data channel to access the user device.

In some embodiments, the module is further configured to cause the at least one processor to: receive, via the first user interface, an indication that the user has selected at least one of the one or more reasons for the user's visit to the facility, wherein the first user interface comprises a plurality of visually perceptible elements corresponding to the first user interface; automatically identify the first user interface as a source page on which the user has indicated the user selection; automatically retrieve data corresponding to the source page; and automatically generate the transformed first user interface that displays: (i) information associated with at least one of the selected reasons for the user's visit to the facility, and (ii) the plurality of visually perceptible elements visually corresponding to the source page.

In some embodiments, the module is further configured to cause the at least one processor to: determine a wait time associated with the execution of one or more transactions associated with the at least one of the selected reasons for the user's visit to the facility.

In some embodiments, the module is further configured to cause the at least one processor to: determine a location information associated with the user device, wherein the location information is determined based on a global positioning system (GPS) device associated with the user device; determine a location information associated with one or more other facilities, the one or more other facilities being associated with the entity; determine at least one of the one or more other facilities for the user to execute one or more transactions associated with the at least one of the selected reasons for the user's visit to the facility based on at least a relative distance between the location information associated with the user device and the location information associated with the one or more other facilities; transmit the at least one of the one or more other facilities to the user device.

In some embodiments, the module is further configure to cause the at least one processor to: determine at least one of the one or more other facilities based on at least the one or more transactions the user wishes to execute, a time period associated with the one or more transactions the user wishes to execute, traffic information associated with the one or more other facilities, and one or more resources associated with the one or more other facilities.

In one aspect, a computer program product for mobile application configuration based on geographic and transaction history context is presented. The computer program product comprises a non-transitory computer-readable medium comprising code causing a first apparatus to: receive an indication that a user device associated with a user is within a predetermined distance from a facility, the facility being associated with an entity; predict one or more reasons for the user's visit to the facility based on at least receiving the indication that the user device is within a predetermined distance from the facility, wherein the one or more reasons for the user's visit is predicted based on at least a predetermined pattern associated with the user's previous visits to the facility; establish a communication link with the user device, wherein the establishing further comprises establishing a data channel to access the user device; initiate a presentation of a first user interface for display on the user device, wherein the first user interface comprises one or more reasons for the user's visit to the facility and one or more options for the user to execute one or more transactions associated with the one or more reasons; receive, via the first user interface, a user selection of at least one of the one or more reasons for the user's visit to the facility; dynamically transform the first user interface to enable the user to execute one or more transactions associated with the at least one of the selected reasons for the user's visit to the facility, whereby the transformation enables the user to initiate execution of one or more transactions efficiently; receive, via the transformed first user interface, a user input to initiate the execution of one or more transactions associated with the at least one of the selected reasons for the user's visit to the facility; and initiate the execution of the one or more transactions associated with the at least one of the selected reasons for the user's visit to the facility.

In yet another aspect, a computer implemented method for mobile application configuration based on geographic and transaction history context is presented. The method comprises: receiving, using a computing device processor, an indication that a user device associated with a user is within a predetermined distance from a facility, the facility being associated with an entity; predicting, using a computing device processor, one or more reasons for the user's visit to the facility based on at least receiving the indication that the user device is within a predetermined distance from the facility, wherein the one or more reasons for the user's visit is predicted based on at least a predetermined pattern associated with the user's previous visits to the facility; establishing, using a computing device processor, a communication link with the user device, wherein the establishing further comprises establishing a data channel to access the user device; initiating, using a computing device processor, a presentation of a first user interface for display on the user device, wherein the first user interface comprises one or more reasons for the user's visit to the facility and one or more options for the user to execute one or more transactions associated with the one or more reasons; receiving, via the first user interface, a user selection of at least one of the one or more reasons for the user's visit to the facility; dynamically transforming, using a computing device processor, the first user interface to enable the user to execute one or more transactions associated with the at least one of the selected reasons for the user's visit to the facility, whereby the transformation enables the user to initiate execution of one or more transactions efficiently; receiving, via the transformed first user interface, a user input to initiate the execution of one or more transactions associated with the at least one of the selected reasons for the user's visit to the facility; and initiating, using a computing device processor, the execution of the one or more transactions associated with the at least one of the selected reasons for the user's visit to the facility.

### BRIEF DESCRIPTION OF THE DRAWINGS

Having thus described embodiments of the invention in general terms, reference will now be made to the accompanying drawings, where:

FIG. 1 illustrates technical components of a system for serving a user at a facility, in accordance with an embodiment of the invention

FIG. 2 illustrates a general process flow for mobile device configuration based on transaction history context, in accordance with an embodiment of the invention; and

FIG. 3 illustrates a process flow for modifying a user interface based on user selection, in accordance with an embodiment of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Embodiments of the invention are directed to systems, methods and computer program products for modifying mobile device configuration based on geographic and transaction history context. The present invention enables an entity to gather and correlate a broad set of information from diverse available data sources from a network of facilities associated with the entity. This information is then used to discover and implement opportunities to improve the entity's ability to service the user. In this regard, the present invention predicts the user's reasons for visiting the entity's facility and based on the user's location, initiates the mobile application to communicate the predicted reasons with the user. In doing so, the present invention provides the functional benefit of configuring the mobile application to enable the user to initiate the transaction associated with the reason for the user's visit to the facility.

In some embodiments, an “entity” as used herein may be a financial institution. A “facility” may be physical premises associated with the entity. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, etc. The account is associated with and/or maintained by the entity. In other embodiments, an “entity” may not be a financial institution. In other embodiments, an entity may or may not allow the user to establish an account associated with the entity.

In some embodiments, the “user” may be a customer (e.g., an account holder or a person who has an account (e.g., banking account, credit account, etc.) at the entity) or potential customer (e.g., a person who has submitted an application for an account, a person who is the target of marketing materials that are distributed by the entity, a person who applies for a loan that not yet been funded). The user may enter the facility or be within a predetermined distance of the entrance to the facility or a system associated with the facility when the user's mobile device establishes communication with the system associated with the facility. The system may be located in the facility or may be located remotely from the facility. An agent may be associated with the facility. The agent may be a human or virtual agent (e.g., computer agent). The agent may be located at the facility or located remotely from the facility. As an example, a computer agent may be associated with the facility may comprise an automated teller machine (ATM) associated with the facility or any other computing system that enables the user to perform a transaction associated with the user's account. Additionally or alternatively, a computer agent associated with the facility may be audio or video conferencing system that enables the user to converse with a human agent (or another computer agent) associated with the entity. In some embodiments, the user may enter the facility using an automobile. For example, the user may enter a drive-through lane associated with the facility.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

In accordance with embodiments of the invention the terms “customer” and “user” and “consumer” may be interchangeable. These terms may relate to a direct customer of the financial institution or person or entity that has authorization to act on behalf of the direct customer, user, or consumer (i.e., indirect customer).

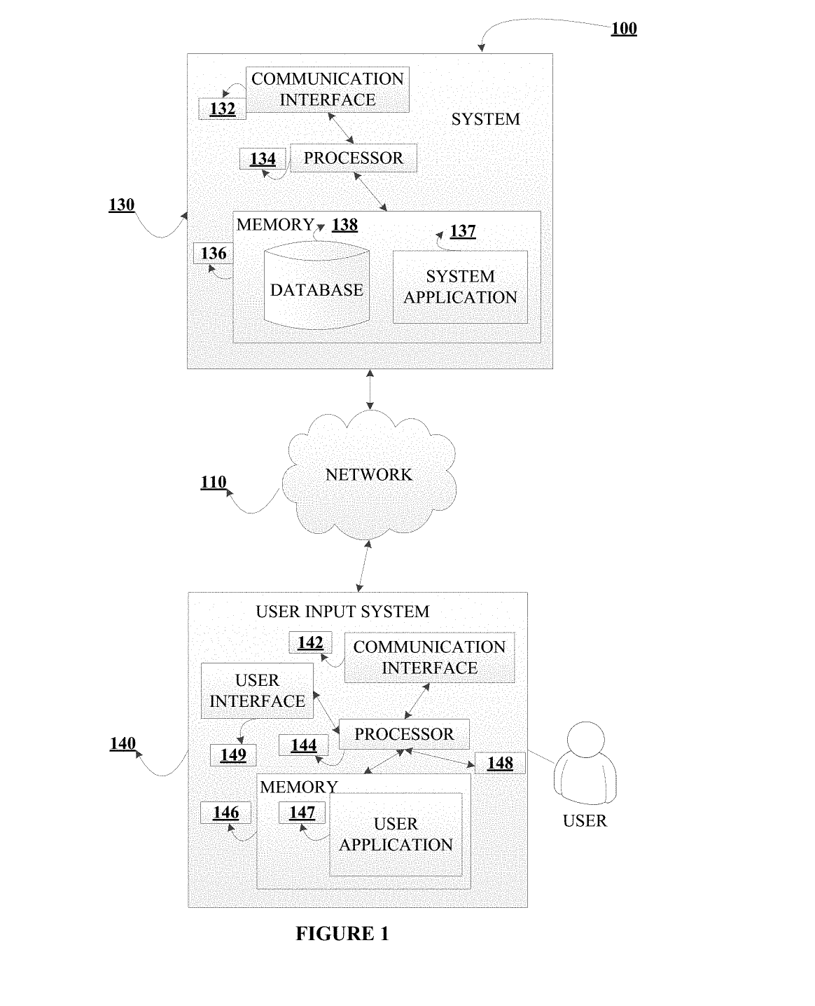

FIG. 1 presents an exemplary block diagram of the system environment 100 for implementing the process flows described herein in accordance with embodiments of the present invention. As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute a user application 147. The user application 147 may be an application to communicate with the system 130, perform a transaction, input information onto a user interface presented on the user input system 140, or the like. The user application 147 and/or the system application 137 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

The user input system 140 may include any computerized apparatus that can be configured to perform any one or more of the functions of the user input system 140 described and/or contemplated herein. For example, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like. In some embodiments, for example, the user input system 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the user input system 140 includes a communication interface 142, a processor 144, a memory 146 having an user application 147 stored therein, and a user interface 149. In such embodiments, the communication interface 142 is operatively and selectively connected to the processor 144, which is operatively and selectively connected to the user interface 149 and the memory 146. In some embodiments, the user may use the user application 147 to execute processes described with respect to the process flows described herein. Specifically, the user application 147 executes the process flows described herein.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the system 130. The wireless transceiver may include a radio circuit to enable wireless transmission and reception of information. Additionally, the user input system 140 may include a positioning system. The positioning system (e.g. a global positioning system (GPS), a network address (IP address) positioning system, a positioning system based on the nearest cell tower location, or the like) may enable at least the user input system 140 or an external server or computing device in communication with the user input system 140 to determine the location (e.g. location coordinates) of the user input system 140.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. Therefore, the system 130 may be a server managed by the business. The system 130 may be located at the facility associated with the business or remotely from the facility associated with the business. In some embodiments, such as the one illustrated in FIG. 1, the system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the structured database 138, the user input system 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the user input system 140 is configured to initiate presentation of any of the user interfaces described herein.

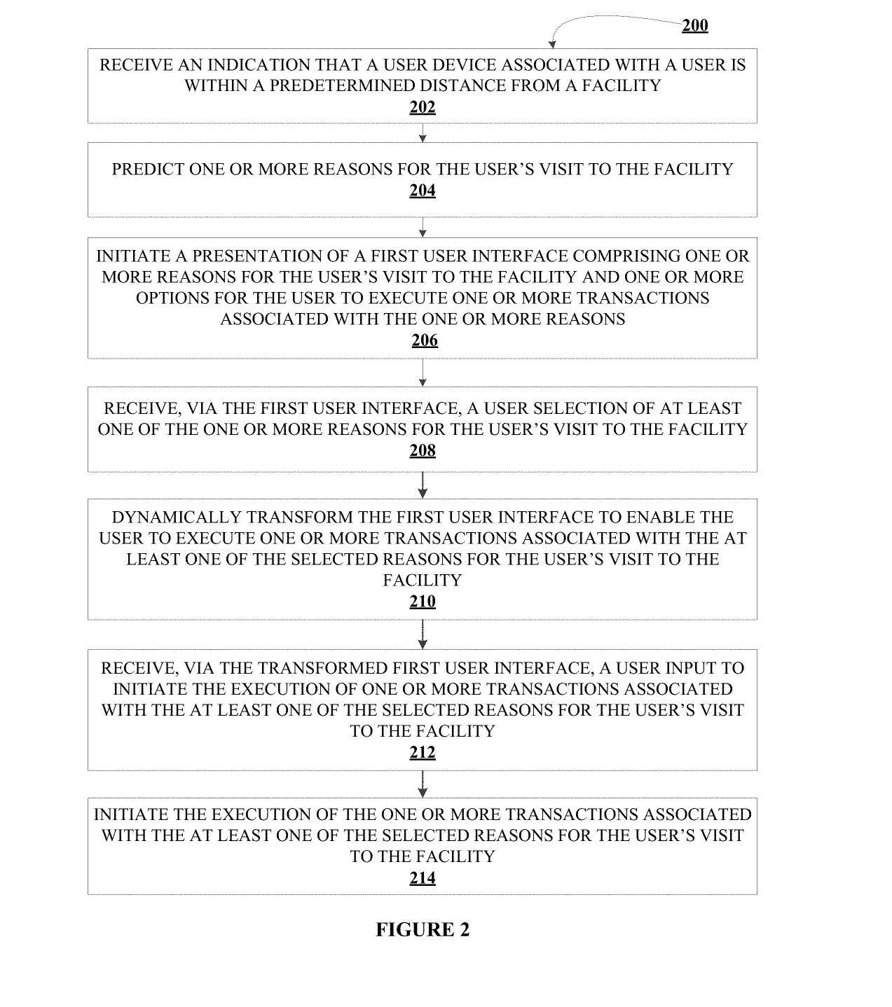

FIG. 2 illustrates a high level process flow for mobile device configuration based on transaction history context 200, in accordance with an embodiment of the invention. As shown in block 202, the process flow includes receiving an indication that a user device associated with a user is within a predetermined distance from a facility. In this regard, the system may be configured to establish a communication link with the user device. As indicated above, the establishing of the communication link creates a data channel between the system and the user device. Typically, if the user device is a mobile device, the data channel is a wireless data channel. In doing so, the system may be configured to enable bi-directional transfer of data between the system and the user device. In this way, the system may be configured to access one or more devices associated with the user device, the devices including, but not limited to, global positioning system device (GPS), image capturing component, microphone, speaker, or the like. Typically, the system may receive an indication that the user is within a predetermined location from the facility using one or more locating methods including, but not limited to, control plane locating, mobile phone tracking, self-reported positioning, Near-Field Communication (NFC), Bluetooth, WLAN, or the like.

Next, as shown in block 204, the process flow includes predicting one or more reasons for the user's visit to the facility. In this regard, the system may be configured to predict the reasons based on at least receiving an indication that the user is within a predetermined distance from the facility. In one aspect, the predetermined distance from the location is determined based on a geographic area defined by a geographic radius, with the facility being the focal point of the geographic area. In this regard, the geographic radius may be defined by the entity, the user, or both.

In some embodiments, the reasons for the user's visit may be predicted based on at least a predetermined pattern associated with the user's previous visits to the facility. In this regard, the system may be configured to enable the entity to receive information associated with the user's previous visits to the facility. In addition, the entity may determine one or more transactions executed by the user during the user's previous visits. In cases where the user has visited the entity's facility, but did not execute any transactions at the facility, the user's previous visits may be determined by at least tracking a location determining device associated with the user device, video surveillance in and around the facility, or the like. In this way, the entity may identify a pattern associated with the user's previous visits to the facility based on at least the transactions executed by the user during the user's previous visits to the facility. In doing so, the entity may be able to predict the reasons for the user's visit to the facility based on at least the pattern associated with the user's previous visits to the facility. For example, the system may receive information from a financial institution (entity) that a customer (user) usually visits a particular financial institution facility (facility) every Tuesday to deposit a weekly paycheck. In doing so, when the system determines that user is within a predetermined distance from the financial institution facility on a Tuesday, the system may predict that the user may be visiting the financial institution facility to deposit a weekly paycheck.

In some embodiments, the system may be configured to validate authentication credentials associated with the user to gain access to the user device. In this way, the user may authorize the system to communicate with the user device. In this regard, the system may be configured to initiate a presentation of an authentication interface for display on the user device in response to receiving the indication that a user device associated with the user is within a predetermined distance from a facility. In response, the system may receive, via the authentication interface, one or more authentication credentials from the user. Examples of authentication credentials include, but are not limited to, username, contact information, a password, a PIN number, biometric information (e.g., physiological features such as fingerprints, finger vein and palm vein patterns, as well as iris and facial recognition to verify individual identities), a unique identification number associated with the user, social network information, an account number, or a card number. In some embodiments, the user information may be proprietary to the entity, such as an account number, a reference number to an account, a client number, or the like. In other embodiments, the user information may be public information, such as a phone number, mailing address, email address, or the like. Once the authentication credentials are received, the system may validate the authentication credentials, and in response to successful authentication, the system may establish a communication link with the device.

Next as shown in block 206, the process flow includes initiating a presentation of a first user interface comprising one or more reasons for the user's visit to the facility and one or more options for the user to execute one or more transactions associated with the one or more reasons. In this regard, the system may be configured to establish a communication link with the user device, thereby establishing a data channel to access the user device. In response, the process flow includes receiving, via the first user interface, a user selection of at least one of the one or more reasons for the user's visit to the facility, as shown in block 208. In some embodiments, the reasons for the user's visit, as determined, may be ranked based on a likelihood rating. In this way, the user may be presented with a list of predicted reasons to choose from. Continuing with the previous example, the user may also visit the financial institution frequently (including Tuesdays) to withdraw a specific amount of money from an automated teller machine (ATM) located within the financial institution facility. In such situations, the system may be configured to determine that the likelihood of the user visiting the financial institution facility on Tuesday to deposit a paycheck is greater than the likelihood of the user visiting the financial institution facility on Tuesday for cash withdrawal. The user may then select at least one of the two reasons (in some cases, both) for the user's visit.

Next, as shown in block 210, the process flow includes dynamically transforming the first user interface to enable the user to execute one or more transactions associated with the at least one of the selected reasons for the user's visit to the facility. In some embodiments, the first user interface may include information to aid the user in execution of the one or more transactions. In this regard, the information may include, but is not limited to a video tutorial, a list of instructions, direct communication line with an agent associated with the facility, or the like. In one aspect, the direct communication line may include a phone call, an instant messenger session, a text message, a pop up message, and an email.

Next, as shown in block 212, the process flow includes receiving, via the first user interface, a user input to initiate the execution of one or more transactions associated with the at least one of the selected reasons for the user's visit to the facility. In some embodiments, the system may be configured to initiate, via the transformed first user interface, an option to enable the user to initiate a partial execution of the one or more transactions. For example, if the user's reason for visiting the financial institution is to withdraw cash from an ATM at the facility, the system may be configured to enable the user to initiate the transaction on the transformed first user interface. In response, the system may be configured to receive, via the transformed first user interface, an indication that the user has initiated the partial execution of one or more transactions. In this regard, the system may receive information associated with the partial execution of the one or more transactions.

Next, in response to receiving the user input, the process flow includes initiating an execution of the one or more transactions associated with the at least one of the selected reasons for the user's visit to the facility, as shown in block 214. For example, the user may enter information associated with the cash amount that the user wishes to withdrawn and an account that the user wishes to withdraw the cash from. In response, the system may be configured to transmit, via the transformed first user interface, a notification to the user indicating a successful partial execution of the one or more transactions. In one aspect, the notification includes information associated with completing the partial execution of the one or more transactions when the user arrives at the facility. For example, the transformed first user interface may provide the user with a notification indicating that the user may directly approach the ATM or an agent at the facility to receive the cash. In this regard, the notification may include a barcode such as a quick response code (QR) to enable the user to authentication himself/herself prior to receiving the cash. In some embodiments, the notification may include a wait time associated with the execution of one or more transactions associated with the at least one of the selected reasons for the user's visit to the facility.

In some embodiments, the system may be configured to determine location information associated with the user device, the location information being determined based on a global positioning system (GPS) device associated with the user device. The system may also determine location information associated with one or more other facilities associated with the entity. In doing so, the system may be configured to determine at least one of the one or more other facilities for the user to execute the one or more transactions based on at least the relative distance between the location information associated with the user device and the location information associated with the one or more other facilities. This may be due to a multitude of factors including, but not limited to, a time period associated with the one or more transactions the user wishes to execute, traffic information associated with the one or more other facilities, and one or more resources associated with the one or more other facilities, or the like.

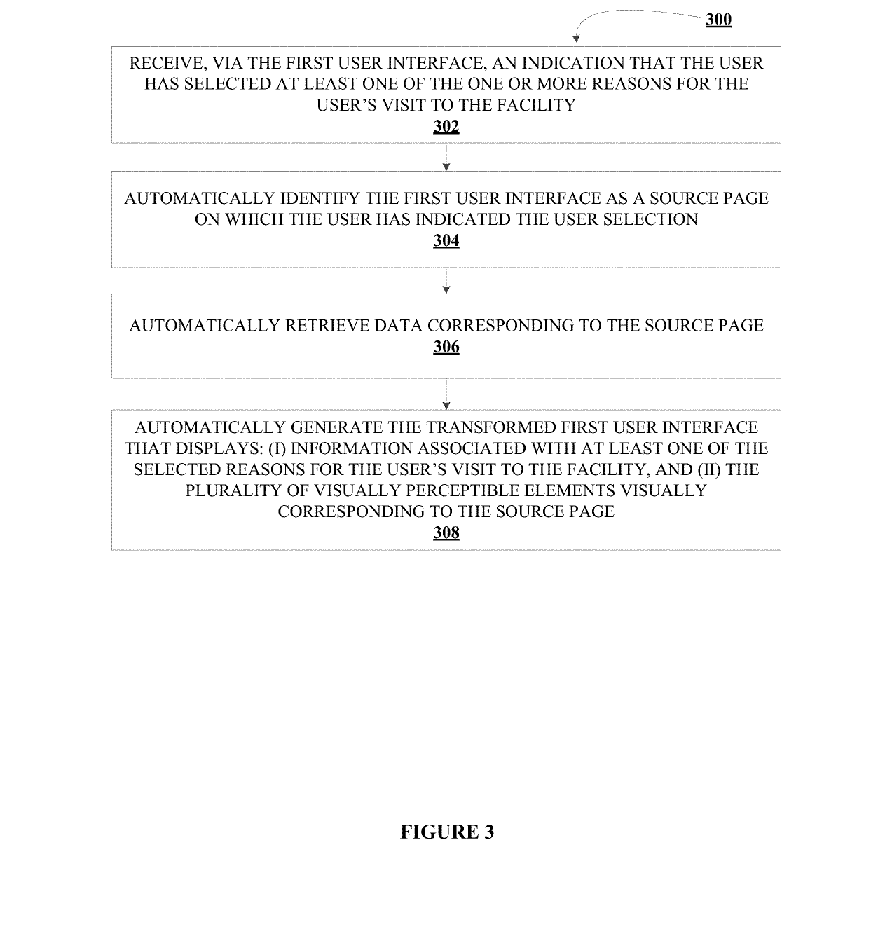

FIG. 3 illustrates a process flow for modifying a user interface based on user selection, in accordance with an embodiment of the invention. As shown in block 302, the process flow includes receiving, via the first user interface, an indication that the user has selected at least one of the one or more reasons for the user's visit to the facility. Typically, the first user interface includes visually perceptible elements such as a multitude of icons or other visual indicators to enable the user to interact with the system. In some embodiments, the system's initiation of the first user interface for display on the user device initiates the transaction application stored in the user device. In one aspect, the user may have to first initiate the transaction application stored in the user device to enable the system to detect the presence of the user device and receive the first user interface.

In response to receiving the user selection, the process flow includes automatically identifying the first user interface as a source page on which the user has indicated the user selection, as shown in block 304. In addition to identifying the first user interface as the source page, the process flow includes automatically retrieving data corresponding to the source page, as shown in block 306. In this regard, the system may be configured to retrieve one or more visually perceptible elements associated with the first user interface. In one aspect, the visually perceptible elements retrieved may be based on the transactions associated with the selected reasons for the user's visit to the facility. In another aspect, the visually perceptible elements retrieved may be based on the transactions associated with the selected reasons and one or more related transactions and/or reasons for the user's visit to the facility.

Next, as shown in block 308, the process flow includes automatically generating the transformed first user interface that displays: (i) information associated with at least one of the one or more reasons for the user's visit to the facility, and (ii) the plurality of visually perceptible elements visually corresponding to the source page. In this regard, the information associated with at least one of the one or more reasons for the user's visit to the facility may include one or more options to enable the user to initiate the transaction or a partial transaction.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent | | |
|---|---|---|---|
| Docket Number | Application Ser. No. | Title | Filed On |
| 6952US1.014033.2574 | To be assigned | MOBILE APPLICATION | Concurrently |
| | | CONFIGURATION BASED | herewith |
| | | ON GEOGRAPHIC AND | |
| | | TRANSACTION HISTORY | |
| | | CONTEXT | |
| 6954US1.014033.2575 | To be assigned | WORK FLOW SCHEDULE | Concurrently |
| | | RECONCILIATION AND | herewith |
| | | DATA PUSH | |
| 6957US1.014033.2576 | To be assigned | MALFEASANCE | Concurrently |
| | | DETECTION BASED ON | herewith |
| | | IDENTIFICATION OF | |
| | | DEVICE SIGNATURE | |
| 6956US1.014033.2577 | To be assigned | RECURRING EVENT | Concurrently |
| | | ANALYSES AND DATA | herewith |
| | | PUSH | |
| 6953US1.014033.2578 | To be assigned | ALTERNATIVE CHANNEL | Concurrently |
| | | SELECTION BASED ON | herewith |
| | | PREDICTIVE WORK FLOW | |

What is claimed is:

1. A system for mobile application configuration based on geographic and transaction history context, the system comprising:
at least one non-transitory storage device;
at least one processor; and
at least one module stored in said storage device and comprising instruction code that is executable by the at least one processor and configured to cause said at least one processor to:
receive an indication that a user device associated with a user is within a predetermined distance from a facility, the facility being associated with an entity;
predict one or more reasons for the user's visit to the facility based on at least receiving the indication that the user device is within a predetermined distance from the facility, wherein the one or more reasons for the user's visit is predicted based on at least a predetermined pattern associated with the user's previous visits to the facility;
establish a communication link with the user device, wherein the establishing further comprises establishing a data channel to access the user device;
initiate a presentation of a first user interface for display on the user device, wherein the first user interface comprises one or more reasons for the user's visit to the facility and one or more options for the user to execute one or more transactions associated with the one or more reasons;
receive, via the first user interface, a user selection of at least one of the one or more reasons for the user's visit to the facility;
dynamically transform the first user interface to enable the user to execute one or more transactions associated with the at least one of the selected reasons for the user's visit to the facility, whereby the transformation enables the user to initiate execution of one or more transactions efficiently;
receive, via the transformed first user interface, a user input to initiate the execution of one or more transactions associated with the at least one of the selected reasons for the user's visit to the facility; and
initiate the execution of the one or more transactions associated with the at least one of the selected reasons for the user's visit to the facility.

2. The system of claim 1, wherein the module is further configured to cause the at least one processor to:
receive information associated with the user's previous visits to the facility;
determine one or more transactions executed by the user during the user's previous visits; and
identify a pattern associated with the user's previous visits to the facility based on at least one or more transactions executed by the user during the user's previous visits to the facility; and
predict the one or more reasons for the user's visit to the facility based on at least the pattern associated with the user's previous visits to the facility.

3. The system of claim 1, wherein the module is further configured to cause the at least one processor to:
initiate, via the transformed first user interface, an option to enable the user to initiate a partial execution of one or more transactions;
receive, via the transformed first user interface, an indication that the user has initiated the partial execution of one or more transactions, wherein receiving further comprises receiving information associated with the partial execution of one or more transactions; and
transmit, via the transformed first user interface, a notification to the user indicating a successful partial execution of the one or more transactions, wherein the notification further comprises information associated with completing the partial execution of the one or more transactions when the user arrives at the facility.

4. The system of claim 1, wherein the module is further configured to cause the at least one processor to:
transmit, via the transformed first user interface, information to aid the user in the execution of the one or more transactions, wherein the information comprises at least a video tutorial, a list of instructions, and direct communication line with an agent associated with the facility, wherein the direct communication line comprises a phone call, an instant messenger session, a text message, a pop up message, and an email.

5. The system of claim 1, wherein the module is further configured to cause the at least one processor to:
initiate a presentation of an authentication interface for display on the user device in response to receiving the indication that a user device associated with a user is within a predetermined distance from a facility;
receive, via the authentication interface, one or more authentication credentials from the user;
validate the one or more authentication credentials; and
establish the communication link with the user device, wherein the establishing further comprises establishing a data channel to access the user device.

6. The system of claim 1, wherein the module is further configured to cause the at least one processor to:
receive, via the first user interface, an indication that the user has selected at least one of the one or more reasons for the user's visit to the facility, wherein the first user interface comprises a plurality of visually perceptible elements corresponding to the first user interface;
automatically identify the first user interface as a source page on which the user has indicated the user selection;
automatically retrieve data corresponding to the source page; and
automatically generate the transformed first user interface that displays: (i) information associated with at least one of the selected reasons for the user's visit to the facility, and (ii) the plurality of visually perceptible elements visually corresponding to the source page.

7. The system of claim 1, wherein the module is further configured to cause the at least one processor to:
determine a wait time associated with the execution of one or more transactions associated with the at least one of the selected reasons for the user's visit to the facility.

8. The system of claim 1, wherein the module is further configured to cause the at least one processor to:
determine a location information associated with the user device, wherein the location information is determined based on a global positioning system (GPS) device associated with the user device;
determine a location information associated with one or more other facilities, the one or more other facilities being associated with the entity;
determine at least one of the one or more other facilities for the user to execute one or more transactions associated with the at least one of the selected reasons for the user's visit to the facility based on at least a relative distance between the location information associated with the user device and the location information associated with the one or more other facilities;
transmit the at least one of the one or more other facilities to the user device.

9. The system of claim 8, wherein the module is further configure to cause the at least one processor to:
determine at least one of the one or more other facilities based on at least the one or more transactions the user wishes to execute, a time period associated with the one or more transactions the user wishes to execute, traffic information associated with the one or more other facilities, and one or more resources associated with the one or more other facilities.

10. A computer program product for mobile application configuration based on geographic and transaction history context, the computer program product comprising a non-transitory computer-readable medium comprising code causing a first apparatus to:
receive an indication that a user device associated with a user is within a predetermined distance from a facility, the facility being associated with an entity;
predict one or more reasons for the user's visit to the facility based on at least receiving the indication that the user device is within a predetermined distance from the facility, wherein the one or more reasons for the user's visit is predicted based on at least a predetermined pattern associated with the user's previous visits to the facility;
establish a communication link with the user device, wherein the establishing further comprises establishing a data channel to access the user device;
initiate a presentation of a first user interface for display on the user device, wherein the first user interface comprises one or more reasons for the user's visit to the facility and one or more options for the user to execute one or more transactions associated with the one or more reasons;
receive, via the first user interface, a user selection of at least one of the one or more reasons for the user's visit to the facility;
dynamically transform the first user interface to enable the user to execute one or more transactions associated with the at least one of the selected reasons for the user's visit to the facility, whereby the transformation enables the user to initiate execution of one or more transactions efficiently;
receive, via the transformed first user interface, a user input to initiate the execution of one or more transactions associated with the at least one of the selected reasons for the user's visit to the facility; and
initiate the execution of the one or more transactions associated with the at least one of the selected reasons for the user's visit to the facility.

11. The computer program product of claim 10, wherein the first apparatus is further configured to cause the at least one processor to:
receive information associated with the user's previous visits to the facility;
determine one or more transactions executed by the user during the user's previous visits; and
identify a pattern associated with the user's previous visits to the facility based on at least one or more transactions executed by the user during the user's previous visits to the facility; and
predict the one or more reasons for the user's visit to the facility based on at least the pattern associated with the user's previous visits to the facility.

12. The computer program product of claim 10, wherein the first apparatus is further configured to cause the at least one processor to:
initiate, via the transformed first user interface, an option to enable the user to initiate a partial execution of one or more transactions;
receive, via the transformed first user interface, an indication that the user has initiated the partial execution of one or more transactions, wherein receiving further comprises receiving information associated with the partial execution of one or more transactions; and
transmit, via the transformed first user interface, a notification to the user indicating a successful partial execution of the one or more transactions, wherein the notification further comprises information associated with completing the partial execution of the one or more transactions when the user arrives at the facility.

13. The computer program product of claim 10, wherein the first apparatus is further configured to cause the at least one processor to:
transmit, via the transformed first user interface, information to aid the user in the execution of the one or more transactions, wherein the information comprises at least a video tutorial, a list of instructions, and direct communication line with an agent associated with the facility, wherein the direct communication line comprises a phone call, an instant messenger session, a text message, a pop up message, and an email.

14. The computer program product of claim 10, wherein the first apparatus is further configured to cause the at least one processor to:
initiate a presentation of an authentication interface for display on the user device in response to receiving the indication that a user device associated with a user is within a predetermined distance from a facility;
receive, via the authentication interface, one or more authentication credentials from the user;
validate the one or more authentication credentials; and
establish the communication link with the user device, wherein the establishing further comprises establishing a data channel to access the user device.

15. The computer program product of claim 10, wherein the first apparatus is further configured to cause the at least one processor to:
receive, via the first user interface, an indication that the user has selected at least one of the one or more reasons for the user's visit to the facility, wherein the first user interface comprises a plurality of visually perceptible elements corresponding to the first user interface;
automatically identify the first user interface as a source page on which the user has indicated the user selection;
automatically retrieve data corresponding to the source page; and
automatically generate the transformed first user interface that displays: (i) information associated with at least one of the selected reasons for the user's visit to the facility, and (ii) the plurality of visually perceptible elements visually corresponding to the source page.

16. The computer program product of claim 10, wherein the first apparatus is further configured to cause the at least one processor to:
determine a wait time associated with the execution of one or more transactions associated with the at least one of the selected reasons for the user's visit to the facility.

17. The computer program product of claim 10, wherein the first apparatus is further configured to cause the at least one processor to:
determine a location information associated with the user device, wherein the location information is determined based on a global positioning system (GPS) device associated with the user device;
determine a location information associated with one or more other facilities, the one or more other facilities being associated with the entity;
determine at least one of the one or more other facilities for the user to execute one or more transactions associated with the at least one of the selected reasons for the user's visit to the facility based on at least a relative distance between the location information associated with the user device and the location information associated with the one or more other facilities;
transmit the at least one of the one or more other facilities to the user device.

18. A computer implemented method for mobile application configuration based on geographic and transaction history context, the method comprising:
receiving, using a computing device processor, an indication that a user device associated with a user is within a predetermined distance from a facility, the facility being associated with an entity;
predicting, using a computing device processor, one or more reasons for the user's visit to the facility based on at least receiving the indication that the user device is within a predetermined distance from the facility, wherein the one or more reasons for the user's visit is predicted based on at least a predetermined pattern associated with the user's previous visits to the facility;
establishing, using a computing device processor, a communication link with the user device, wherein the establishing further comprises establishing a data channel to access the user device;
initiating, using a computing device processor, a presentation of a first user interface for display on the user device, wherein the first user interface comprises one or more reasons for the user's visit to the facility and one or more options for the user to execute one or more transactions associated with the one or more reasons;
receiving, via the first user interface, a user selection of at least one of the one or more reasons for the user's visit to the facility;
dynamically transforming, using a computing device processor, the first user interface to enable the user to execute one or more transactions associated with the at least one of the selected reasons for the user's visit to the facility, whereby the transformation enables the user to initiate execution of one or more transactions efficiently;
receiving, via the transformed first user interface, a user input to initiate the execution of one or more transactions associated with the at least one of the selected reasons for the user's visit to the facility; and
initiating, using a computing device processor, the execution of the one or more transactions associated with the at least one of the selected reasons for the user's visit to the facility.

19. The method of claim 18, wherein the method further comprises:
receiving information associated with the user's previous visits to the facility;
determining one or more transactions executed by the user during the user's previous visits; and
identifying a pattern associated with the user's previous visits to the facility based on at least one or more transactions executed by the user during the user's previous visits to the facility; and
predicting the one or more reasons for the user's visit to the facility based on at least the pattern associated with the user's previous visits to the facility.

20. The method of claim 18, wherein the method further comprises:
initiating, via the transformed first user interface, an option to enable the user to initiate a partial execution of one or more transactions;
receiving, via the transformed first user interface, an indication that the user has initiated the partial execution of one or more transactions, wherein receiving further comprises receiving information associated with the partial execution of one or more transactions; and
transmitting, via the transformed first user interface, a notification to the user indicating a successful partial execution of the one or more transactions, wherein the notification further comprises information associated with completing the partial execution of the one or more transactions when the user arrives at the facility.
